(19) United States
(12) Patent Application Publication
(10) Pub. No.: US 2013/0069962 A1
(43) Pub. Date: Mar. 21, 2013

(54) Active Lock Wallpapers

(71) Applicants: Bryan Welbourne Nealer, Seattle, WA (US); Joshua DeBrita Phillips, Seattle, WA (US); Kathryn Carter Lemson, Redmond, WA (US); Lejie Xu, Redmond, WA (US); Jonathan David Canan, Bellevue, WA (US); Marc S. Doll, Seattle, WA (US)

(72) Inventors: Bryan Welbourne Nealer, Seattle, WA (US); Joshua DeBrita Phillips, Seattle, WA (US); Kathryn Carter Lemson, Redmond, WA (US); Lejie Xu, Redmond, WA (US); Jonathan David Canan, Bellevue, WA (US); Marc S. Doll, Seattle, WA (US)

(73) Assignee: Microsoft Corporation, Redmond, WA (US)

(21) Appl. No.: 13/234,037

(22) Filed: Sep. 15, 2011

(51) Int. Cl. G06T 15/00

(52) U.S. Cl. 345/522

(57) ABSTRACT

The subject disclosure is directed towards a technology in which a mobile device such as a phone automatically changes its lock wallpaper content (e.g., an image or video) that appears when the device is in its lock state. An API or the like allows information to be received from an application or service according to which the content is changed, including obtaining the content as needed. The lock wallpaper content may change in response to an automatic change event, and may correspond to a current device context. For example, lock wallpaper content may be displayed based upon a currently playing podcast, audio track, or currently running application program or service. The lock wallpaper may change among content obtained from a social networking site, or from a favorites store. The device may allow gesturing to change the content.

### BACKGROUND

A touch screen mobile device (e.g., a smartphone) uses a ‘lock screen’ to prevent accidental touches that otherwise may be detected by the device software when the device is not actively being used. The lock screen also appears when the device is initially turned on. The lock screen typically conveys the time, date, message notifications, and system status such as cellular signal strength and battery level.

Contemporary mobile devices allow a user to specify an image, sometimes referred to as ‘lock wallpaper’ that appears beneath the conveyed information when the device is in the lock screen state. For example, the lock wallpaper appears when the user first touches a button to get the device to light up the display screen after the screen has gone dark (timed out) due to inactivity. The lock wallpaper thus appears before the user sees his or her home screen of application icons (those that may appear above regular wallpaper).

In general, the lock wallpaper conveys little or no information other than possibly that the user has the correct device (and not a family member's or friend's similar or identical model of the device but having a different image, for example), and that the user needs to interact further to get to the user's applications for launching. However, this is limited and very basic information, and thus not particularly useful.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which lock wallpaper content (e.g., an image, video, animation and so forth) that appears when a device is in a lock state is automatically changed from displaying first lock wallpaper content to second, different lock wallpaper content. In one aspect, the device is configured with a component interface by which lock wallpaper information, corresponding to a current device context, is received. The lock wallpaper information specifies lock wallpaper content to display when the device is in the lock screen state. The device obtains the lock wallpaper content based on the lock wallpaper information, and outputs that content to a device display screen.

For example, the current context may correspond to a currently playing podcast, and the lock wallpaper information may comprise content and/or a reference to content within podcast metadata. The lock wallpaper information may correspond to one or more keywords within the podcast metadata, and/or one or more words recognized from speech of the currently playing podcast, with the device obtaining the content by requesting a keyword/word-based search.

The current context may correspond to a currently playing audio track, or an application program or service. The lock wallpaper information comprises content specified by the application program, e.g., audio-track related data for an audio track, and advertisement for another application program, and so forth.

In one aspect, the lock wallpaper content change occurs in response to an automatic change event. Example automatic change events include changing among lock wallpaper content obtained from a social network source content store, e.g., by a time-based event or by a social network notification received at the device. Time-based automatic change events may be used to change lock wallpaper content among a user's specified favorites, which may also be changed by detected gestures that generate automatic change events. Another source of active lock wallpaper comprises a remote source that adds content via an authorized entity, such as another person to whom automatic setting of the lock wallpaper has been delegated.

In one aspect, while the device is displaying lock wallpaper selected from a set of user-specified content at a user-defined change interval, the device may detect a user gesture and in response automatically change the device lock wallpaper. Based upon the gesture, other information displayed in conjunction with the lock wallpaper may be removed/faded out for a time. The other information may be restored/faded in when the device does not detect further user gesturing within a time interval.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components of one example implementation for actively changing lock wallpaper content.

FIG. 2A is a flow diagram representing example steps for displaying and changing lock wallpaper content based upon information specified in podcast metadata associated with a currently playing podcast.

FIG. 2B is a flow diagram representing example steps for displaying and changing lock wallpaper content based upon keyword information extracted from podcast metadata associated with a currently playing podcast.

FIG. 2C is a flow diagram representing example steps for displaying and changing lock wallpaper content based upon speech information recognized from podcast speech of a currently playing podcast.

FIG. 3 is a flow diagram representing example steps for displaying and changing lock wallpaper content based upon a currently playing audio track.

FIG. 4 is a flow diagram representing example steps for displaying and changing lock wallpaper content (e.g., an advertisement) based upon a currently running application, (e.g., a personal audio station).

FIG. 5 is a flow diagram representing example steps for displaying and changing lock wallpaper content based upon a social network's source of content.

FIG. 6 is a flow diagram representing example steps for allowing remote configuration of device lock wallpaper, including displaying and changing lock wallpaper content from a specified content source.

FIG. 7 is a flow diagram representing example steps for displaying and changing lock wallpaper content based upon a user-specified set of favorite content.

FIG. 8 is a flow diagram representing example steps for displaying and changing lock wallpaper content based upon a detected user gesture.

FIG. 9 is a block diagram representing an exemplary non-limiting computing system or operating environment, e.g., in the example of a mobile phone device, in which one or more aspects of various embodiments described herein can be implemented.

### DETAILED DESCRIPTION

Various aspects of the technology described herein are generally directed towards a technology by which lock wallpaper (e.g., content comprising an image, video or animation) is automatically selected and displayed on the device screen. The lock wallpaper thus varies, such as based on a current device or software program context, or other automatic change event. The context may correspond to an application, or the current state of an application, including for a background application or service that is not running in the foreground (and thus typically does not have control of the display). For example, a currently running podcast that is recounting/analyzing a sporting event may have lock wallpaper that is related to that sporting event in some general or more specific way.

It should be understood that any of the examples herein are non-limiting. For example, while a touch-screen mobile device/smartphone are used as examples herein, at least some of the concepts described herein are applicable to a personal computer or the like. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and content display in general.

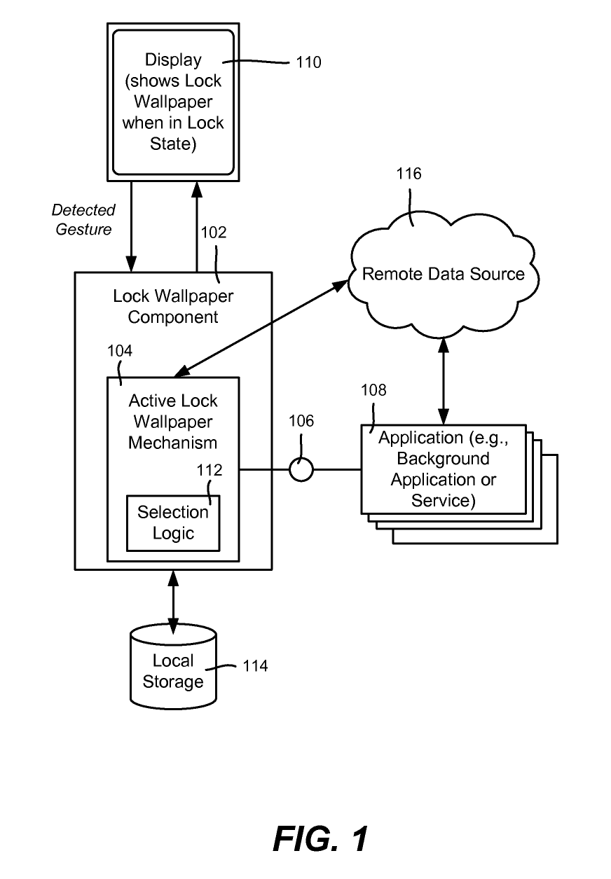

FIG. 1 is a block diagram showing various components in one example implementation. In general, a first party (e.g., operating system vendor-provided) lock wallpaper component 102 includes or is otherwise coupled to an active lock wallpaper mechanism 104. For example, the lock wallpaper component 102 may be incorporated into the operating system and accessed by the user via a “Settings” user interface.

In one aspect, the active lock wallpaper mechanism 104 (and/or the component 102) includes an application programming interface (API) 106 or the like by which an application 108 (or service) may specify or request that the lock wallpaper be actively changed/output, such as based upon current context data or other automatic change event. Note that an “automatic” change event is in contrast to a user manually going to the device Settings menu and choosing a different image, as is currently done.

The application or service may be a first party program, or a third party program (e.g., from a different software vendor). Note that while a background application is one example application 108, the application may be a foreground application, such as one that is planning to relinquish control of the display screen 110, e.g., by moving to the background. A user interface also may be used to change the lock wallpaper, including via gesture detection as described below.

Note that for a user to see the lock wallpaper, the device need not actually be in a state in which the user needs to unlock the device with a PIN (personal identification number). This may happen, for example, because not all users use PINs, or because the timeout that locks the device may be longer than the screen inactivity timeout, whereby the user may resume activity and thereby reenergize the display before the device locks. Further, the lock wallpaper may be output anytime the operating system (e.g., the component 102) specifies that it be output. Thus, as used herein, “lock wallpaper” may appear on the screen even on an unlocked device.

As described below, the active lock wallpaper mechanism 104 may include selection logic 112 that determines what display content (e.g., a set of one or more images and/or videos) needs to be retrieved from local storage 114 and/or a remote data source 116 for outputting to the display as the lock wallpaper. The selection logic 112 is also configured to receive any lock-wallpaper related data (such as metadata and/or a reference to displayable content) from the application 108.

In one implementation, if more than one application or service is requesting that the active lock wallpaper mechanism 104 show different content, the selection logic 112 may include rules, priority data and so forth to resolve the conflict. For example, if one application or service wants a friend-related image set shown based upon its current context of having received a social networking notification from a friend, and another application or service wants to show a map based upon its current context of having current GPS coordinates, the map may be selected based upon an importance ranking, which may be user configurable.

The lock wallpaper component 102/active lock wallpaper mechanism 104 may decide when to enter the lock state to show the lock wallpaper, such as by using a conventional lock screen timeout mechanism. Alternatively, the application or service may request a time or specify an event to show the content, such as show the lock wallpaper right away, or when the application moves to the background or closes. As mentioned above, this may be independent of whether the screen is actually locked.

By way of example, consider that a background application or service is playing a podcast as started by a user. Instead of the conventional lock wallpaper, the background application 108 or service (or the selection logic 112) may direct the lock wallpaper mechanism 104 to output lock wallpaper (e.g., an image or video) that is related to the podcast.

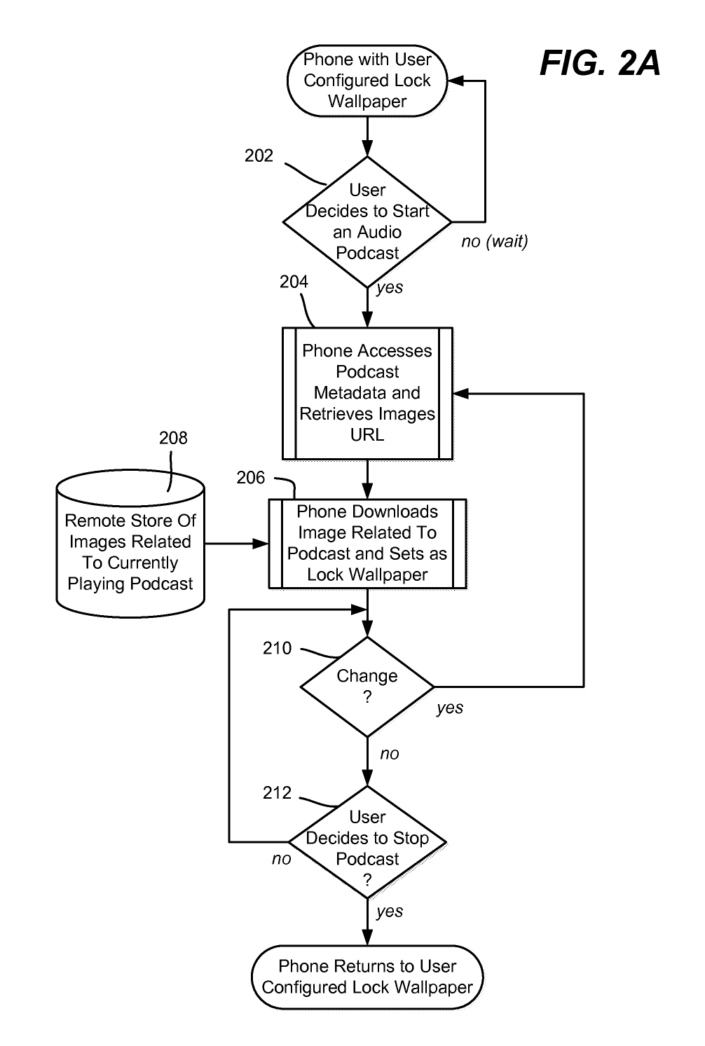

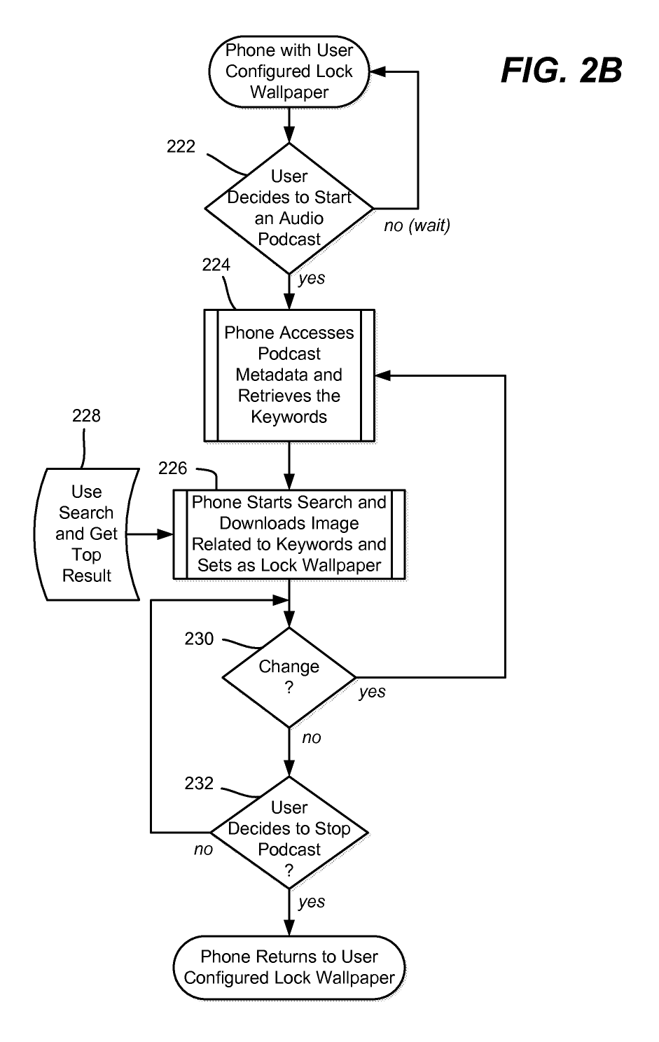

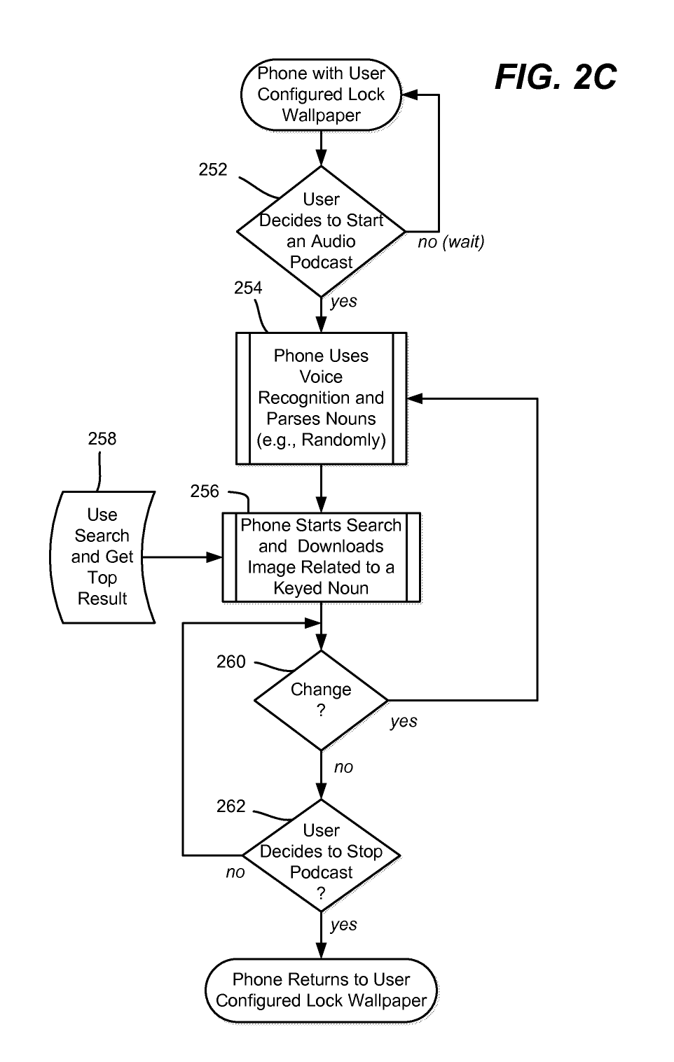

FIGS. 2A-2C show some examples of how the active wallpaper mechanism and selection logic operate in conjunction with the podcast to display such active lock wallpaper content. For example, if listening to a podcast recounting a baseball game, the lock wallpaper may be updated to output visible content (e.g., an image, video or animation) related to a particular player. For example, a podcast may embed an image or URL link from which to retrieve images, the podcast's metadata may be used to search for relevant images, or speech recognition software may be used to help retrieve images based on repeated words and/or certain keywords recognized in the podcasts.

In FIG. 2A, the user starts a podcast as represented by step 202; (the “no (wait)” branch represents waiting until such an event occurs, and may be event driven rather than a loop as depicted). At step 204, in this alternative the podcast is associated with metadata, which the active lock wallpaper mechanism 104/selection logic 112 (referred to as the “phone” in the drawings and this example for brevity) accesses. In this example, the metadata contains a reference (e.g., a URL) to an image or other visible content, which the phone downloads at step 206 from a suitable data store 208 and actively sets (outputs) as the lock wallpaper. Note that the metadata itself may contain the image or other content, however the metadata most likely contains a reference thereto.

As represented by step 210, the lock wallpaper remains selected during the podcast, unless the podcast changes the metadata (e.g., to show a different player during the baseball podcast), or the metadata specifies a change, e.g., switch to a different URL upon some change event, such as after a time duration. Step 212 represents the user ending the podcast, which in this example restores the lock wallpaper to the user-configured lock wallpaper (or device default if the user has not yet configured the lock wallpaper).

FIG. 2B is somewhat similar to FIG. 2A, except that instead of having the podcast metadata specify the URL, the podcast metadata includes keywords that the phone accesses at step 224 and uses in a query or the like to search for/download a suitable image (or video) via step 226. Block 228 represents a search engine or the like that returns displayable content in response to a keyword search and download request. The lock wallpaper remains until there is some change (step 230) or the user stops the podcast (step 232).

FIG. 2C is similar to FIG. 2B, except that instead of having the podcast metadata provide the keywords, at step 254 the phone uses speech recognition to obtain them. Nouns may be parsed from the recognized text and randomly selected, or selected in some other manner, e.g., by some popularity measure, and/or by player names recognized during a baseball podcast). At step 256 the phone uses one more of the selected nouns in a query or the like to search for/download a suitable image (or video) via step 256. Block 258 represents a search engine or the like that returns displayable content in response to a keyword search and download request. The lock wallpaper remains until there is some change (step 250), such as a new speech recognition cycle, or the user stops the podcast (step 252).

In this way, the current context of the podcast in the form of metadata that specifies content (FIG. 2A), metadata that provides keywords used to obtain content (FIG. 2B), or speech recognition of the podcast that provides keywords used to obtain content (FIG. 2C) may be used to select and display different lock wallpaper. Other ways of selecting images relevant to a podcast are feasible.

By way of another example, consider that a service or a background application comprises a background audio player. Instead of the conventional lock wallpaper, the background application may provide information to the active lock wallpaper mechanism that relates to the current audio track in some way (e.g., artist, title and/or album). The selection logic 112 may retrieve an image of the artist (or of the album cover, for example) from local storage or the remote data source, and display that content as the current lock wallpaper based upon the current context of that song being played. The active lock wallpaper mechanism may modify the image, such as by superimposing text over the image that indicates the artist, title and/or album data. Via an application interface call or the like, the audio player may change the wallpaper when desired, such as when the song changes.

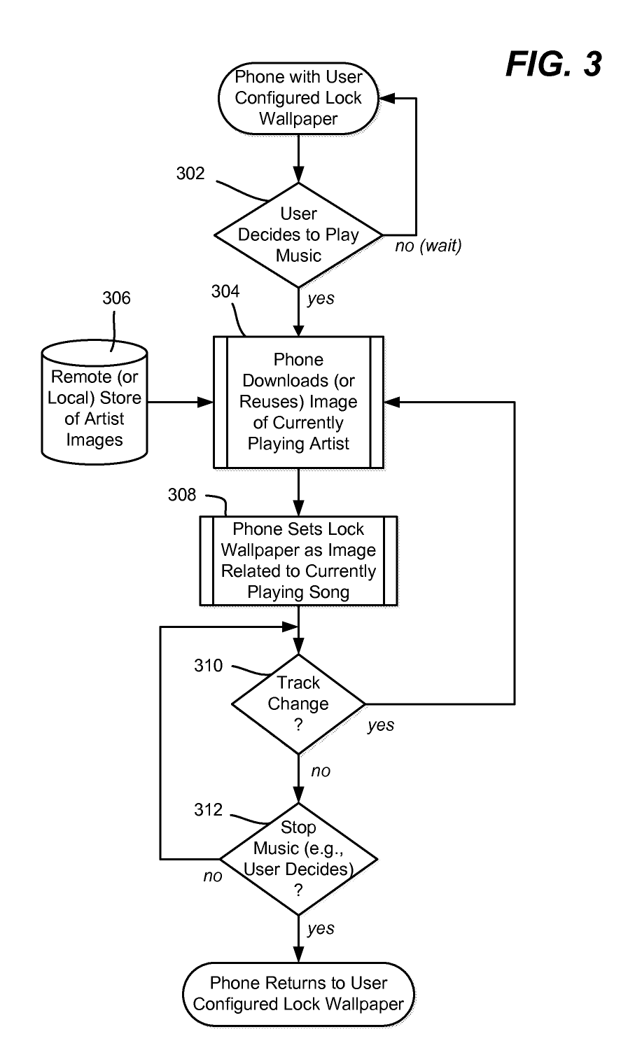

FIG. 3 shows how the active wallpaper mechanism and selection logic operate in conjunction with the application to display such active lock wallpaper content beginning at step 302 when the user decides to play music or other audio. Step 304 represents downloading (or otherwise accessing) a relevant image, video or the like for the song from a data store 306. In the example of FIG. 3 is an image of the artist, but may comprise other content. Step 308 displays the content as the lock wallpaper. Note that it is feasible that such visible content may be locally cached, or obtained when the song is purchased (e.g., the song comes with images or video). It is also feasible that when the song changes (step 310), the artist is the same, and thus the image may be reused if appropriate. The audio player may provide general data (e.g., a song identifier) or more specific data (a particular image or video URL) that the selection logic uses to obtain the corresponding image. When the user stops playing music, (step 312), the user-configured lock wallpaper is restored.

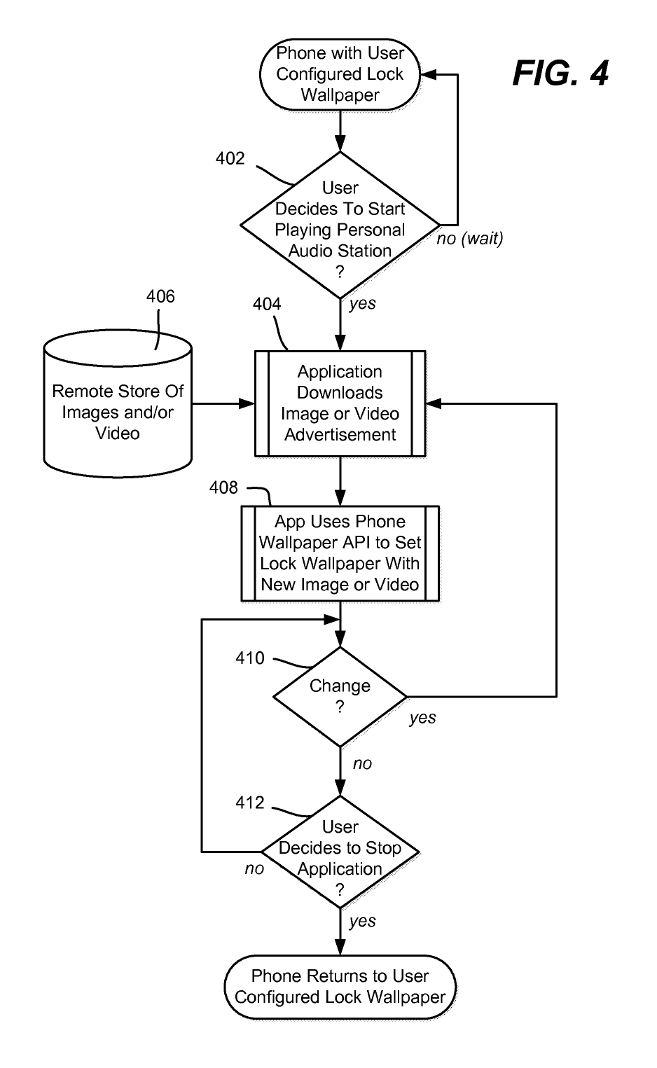

FIG. 4 comprises another example of active lock wallpaper selection and output. In FIG. 4, a user decides at step 402 to play a personal audio station, (or run another application that may be tied to advertising; a personal audio station is used as an example application for this example). At step 404 the application downloads an advertisement or other content (image or video) from a remote store 406, and uses the API 106 (FIG. 1) to set the lock wallpaper to this advertisement or other content. The application may then go into the background or the like, relinquishing control of the screen, with the lock wallpaper showing the content. The application (such as while running in the background) may change the content at step 410, with the lock wallpaper remaining until the user decides to stop the application at step 412. Note that as described above, another application or the like may also cause change by winning a conflict resolution, however this is not shown in FIG. 4 for purposes of simplicity.

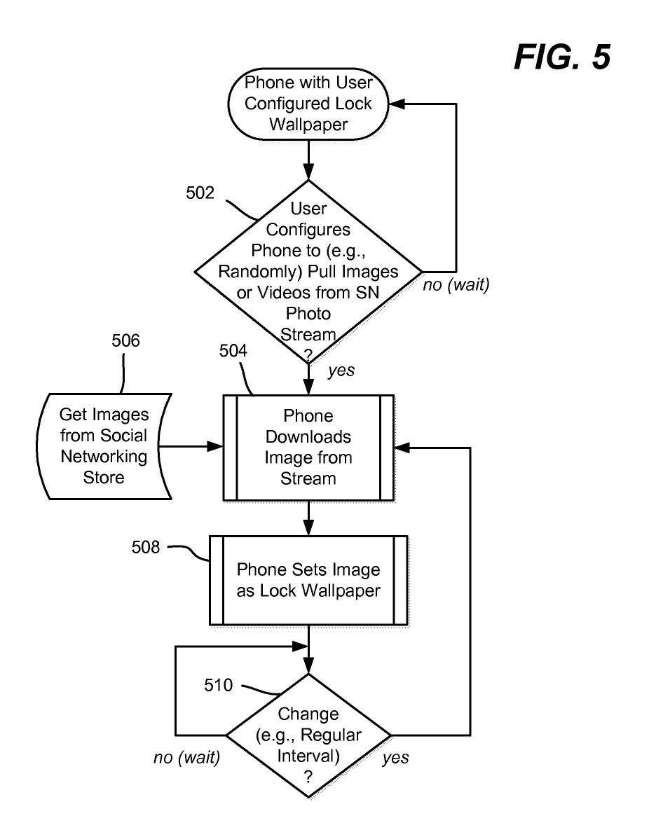

FIG. 5 is related to lock wallpaper that actively changes based upon a social networking (SN) source. In general, at step 502 the user configures the device to pull images from a social networking photo stream; it is also feasible for the site to push images to the phone. At an appropriate change event such as reaching a time interval, which may be on a regular or occasional basis, the phone downloads (step 504) an image (or possibly more than one for caching purposes) from the social networking site's data store 506. This image is set as the lock wallpaper at step 508, e.g., via the API as accessed by a background service. Step 510 changes the image, e.g., on a change event, such as a time event that occurs on a regular interval.

Note that changes made to the social network's store of images, such as by friends or friends of friends, may provide the wallpaper as they may be successively, randomly or otherwise selected, that is, the lock wallpaper may show a set of images corresponding to the user's social networking graph. For example, the user may automatically see pictures of his or her brother's recent trip, which the brother shared openly with his friends via the social networking site.

Further, instead of, or in addition to regular or occasional wallpaper changes, the download may be triggered by a non-timed event, such as a social network notification from a friend. Upon such a notification, the image may be downloaded from a source of images related to that particular friend.

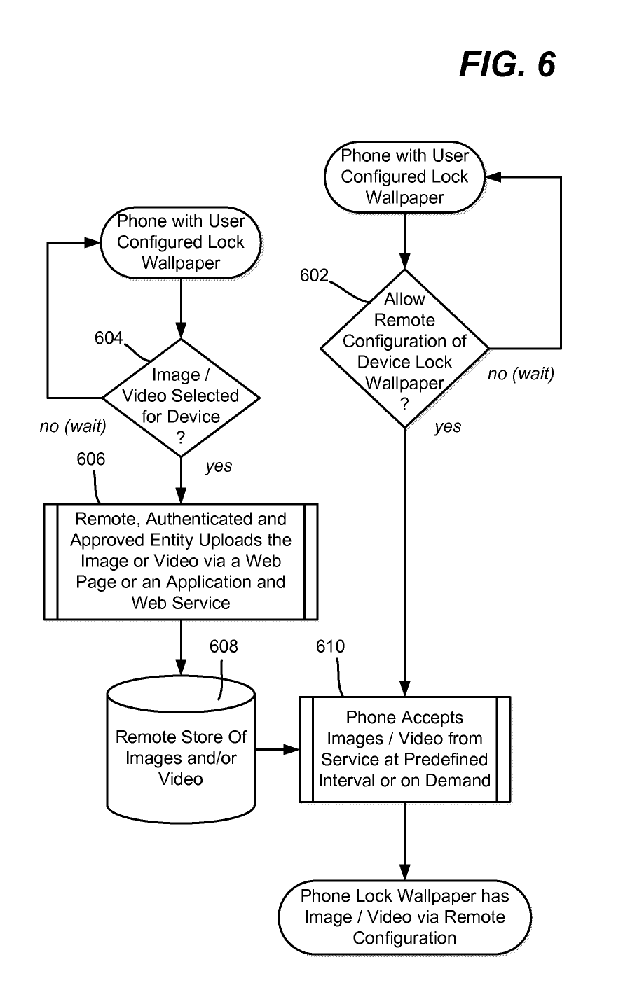

FIG. 6 shows another aspect of active lock wallpaper, namely allowing a user to grant remote access to the device wallpaper so that approved others (e.g., third-party entities such as friends, family, newspapers, blogs, and the like) may set the image, video or other content remotely. For example, this allows a technologically competent person to set her technologically-challenged mother's phone with pictures and video of her grandchildren.

A web front end and/or web service is provided to allow a user to select other users that are allowed to update their wallpaper. Authentication may be handled via a social network, via Windows® Live IDs, or other unique identifiers sent via messaging.

At step 602, the user configures the device to allow one or more specified entities to perform remote configuration. This may include accessing the web front end and/or web service, (access is typically accomplished via the device, but may be done via another computer, provided that the user can correctly identify himself or herself), and also have the device set with this configuration setting.

At some other time, at steps 604 and 606, an authorized entity uploads an image or other content to a remote store 608, such as using a web page or an application and web service. At step 610, the phone accepts the image, e.g., by polling at an interval, or via a push/notification on demand.

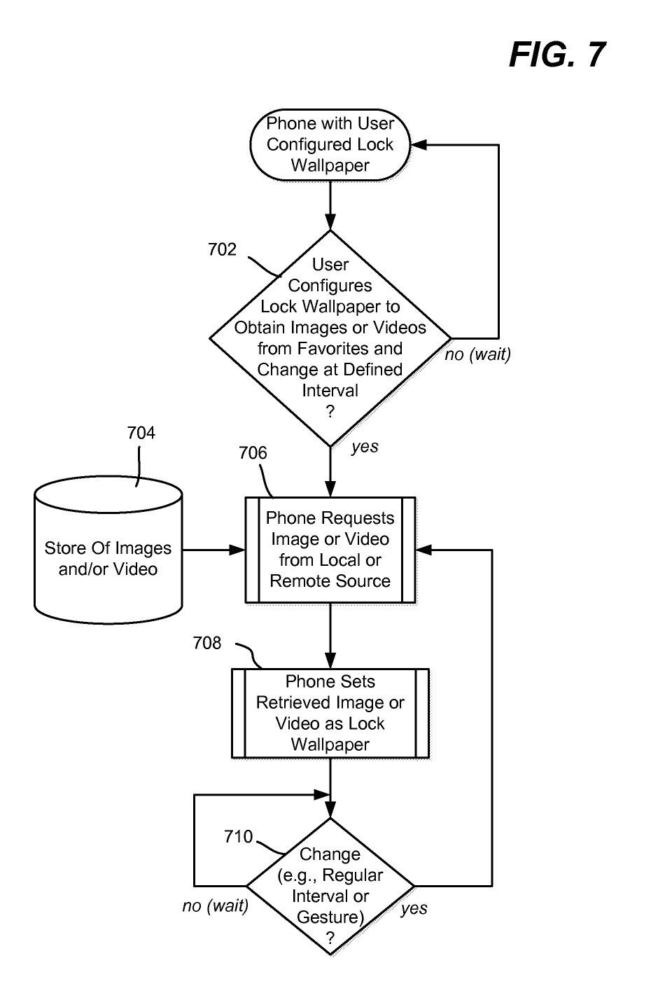

Turning to another aspect, FIG. 7 represents allowing a user to mark photos and videos as favorites, thereby generating a set of favorites. Once the device is configured at step 702, the set of favorites may be used as a source store 704 for loading (steps 706 and 708) an actively rotating (or randomly selected) carousel of lock wallpapers (rather than having a single, static lock wallpaper image). Configuration may include whether to select the favorites or have only a single image as the lock wallpaper, and if favorites are selected, how frequently to change the lock wallpaper.

As represented by step 710, the lock wallpaper may be changed automatically at a configurable interval, for example, or manually by the user gesturing to flip between images, including when the phone is locked. This allows the user to view and/or show off favorite photos or videos without even unlocking the phone. As part of configuration, settings are available where the user can choose how often the lock wallpaper is to switch. Based on this interval setting, the system automatically changes the wallpaper per the user's preference.

In one implementation, a photo and video library on the device maintains metadata for each item, including a flag that marks whether the item is among the user's ‘favorites’. Note that when the user tags images as favorites, the user can do so on the phone itself, or on another device before transferring the images to their phone. The metadata follows the image file, whereby the user can, for example, use a personal computer to select which images are the favorites, and copy them to the phone. The phone respects (which may be a user-configurable option) the favorites choices made on the personal computer, and uses those favorites as part (or all) of the rotating wallpaper set.

Tagging an image as a favorite initiates a flow whereby a copy is made, with the copy automatically centered/cropped to fit the dimensions of the full screen of the device. The copy may be stored in a location on the file system (e.g., the source store 744) where the copy is accessible for use in the rotating set (or randomly selected set) of wallpaper images.

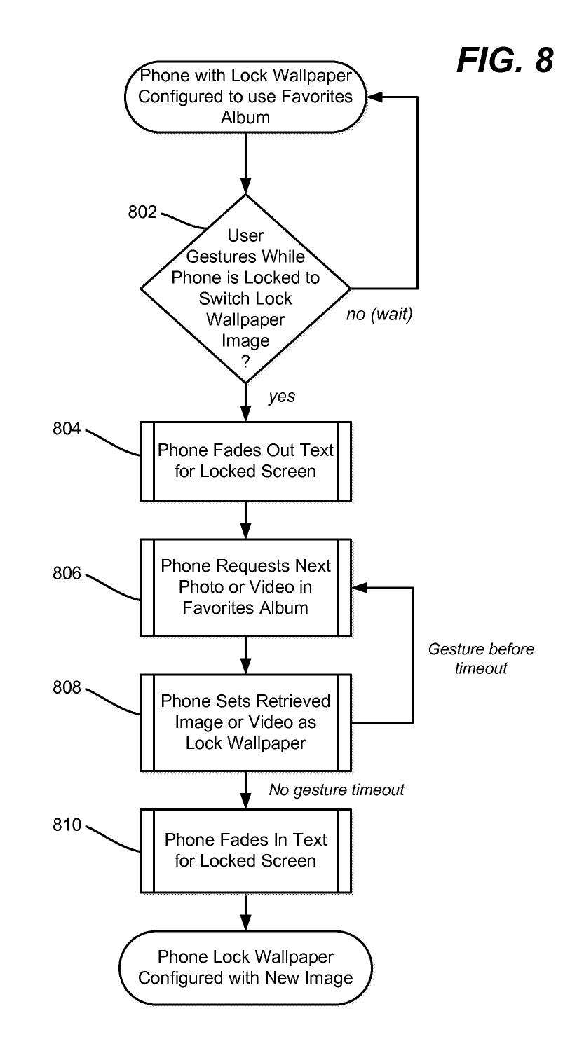

As also represented at step 710 and further described in FIG. 8, regardless of the automatic change interval, the user may gesture on the screen while the device is locked to change to a new image, such as via a specific predefined gesture, e.g., sliding a finger on the screen over an image. The set of photos and videos that were marked as favorites are made available, e.g., in a rotating carousel, through which the user can flip through the phone is locked.

While gesturing (step 802) and for a time thereafter, the text for the lock screen fades out at step 804 to allow enjoyment of the image or video. If the user stops gesturing to select a different image or video (step 806 and 808) for a determined length of time, the text fades back in at step 810 and the image that the user stopped on becomes the new wallpaper image. Automatic switching of the favorites may then resume.

### Exemplary Operating Environment

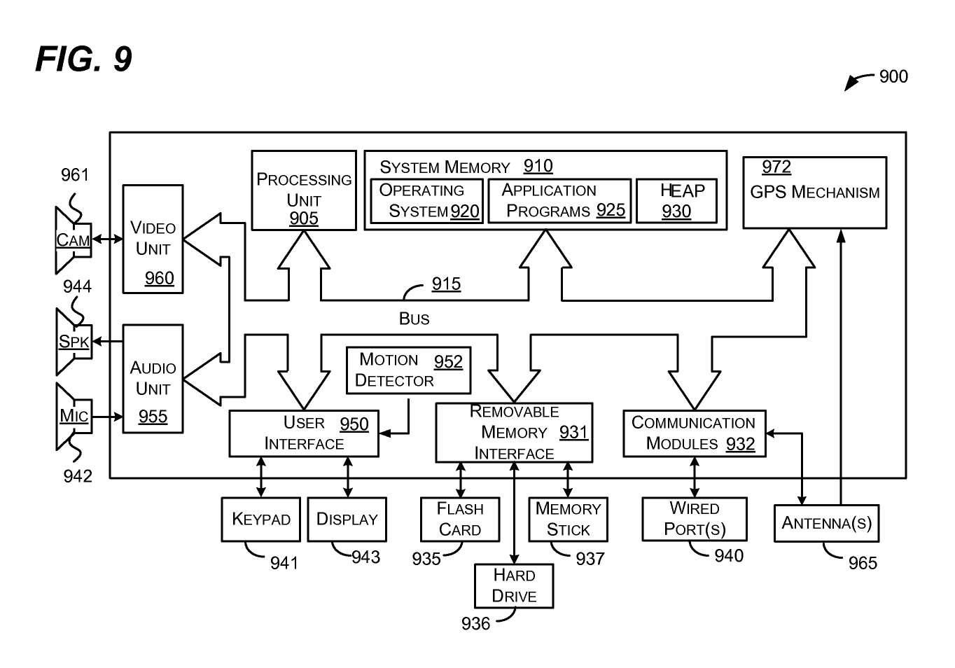

FIG. 9 illustrates an example of a suitable mobile device 900 on which aspects of the subject matter described herein may be implemented. The mobile device 900 is only one example of a device and is not intended to suggest any limitation as to the scope of use or functionality of aspects of the subject matter described herein. Neither should the mobile device 900 be interpreted as having any dependency or requirement relating to any one or combination of components illustrated in the exemplary mobile device 900.

With reference to FIG. 9, an exemplary device for implementing aspects of the subject matter described herein includes a mobile device 900. In some embodiments, the mobile device 900 comprises a cell phone, a handheld device that allows voice communications with others, some other voice communications device, or the like. In these embodiments, the mobile device 900 may be equipped with a camera for taking pictures, although this may not be required in other embodiments. In other embodiments, the mobile device 900 may comprise a personal digital assistant (PDA), hand-held gaming device, notebook computer, printer, appliance including a set-top, media center, or other appliance, other mobile devices, or the like. In yet other embodiments, the mobile device 900 may comprise devices that are generally considered non-mobile such as personal computers, servers, or the like.

Components of the mobile device 900 may include, but are not limited to, a processing unit 905, system memory 910, and a bus 915 that couples various system components including the system memory 910 to the processing unit 905. The bus 915 may include any of several types of bus structures including a memory bus, memory controller, a peripheral bus, and a local bus using any of a variety of bus architectures, and the like. The bus 915 allows data to be transmitted between various components of the mobile device 900.

The mobile device 900 may include a variety of computer-readable media. Computer-readable media can be any available media that can be accessed by the mobile device 900 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 900.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 910 includes computer storage media in the form of volatile and/or nonvolatile memory and may include read only memory (ROM) and random access memory (RAM). On a mobile device such as a cell phone, operating system code 920 is sometimes included in ROM although, in other embodiments, this is not required. Similarly, application programs 925 are often placed in RAM although again, in other embodiments, application programs may be placed in ROM or in other computer-readable memory. The heap 930 provides memory for state associated with the operating system 920 and the application programs 925. For example, the operating system 920 and application programs 925 may store variables and data structures in the heap 930 during their operations.

The mobile device 900 may also include other removable/non-removable, volatile/nonvolatile memory. By way of example, FIG. 9 illustrates a flash card 935, a hard disk drive 936, and a memory stick 937. The hard disk drive 936 may be miniaturized to fit in a memory slot, for example. The mobile device 900 may interface with these types of non-volatile removable memory via a removable memory interface 931, or may be connected via a universal serial bus (USB), IEEE 9394, one or more of the wired port(s) 940, or antenna(s) 965. In these embodiments, the removable memory devices 935-937 may interface with the mobile device via the communications module(s) 932. In some embodiments, not all of these types of memory may be included on a single mobile device. In other embodiments, one or more of these and other types of removable memory may be included on a single mobile device.

In some embodiments, the hard disk drive 936 may be connected in such a way as to be more permanently attached to the mobile device 900. For example, the hard disk drive 936 may be connected to an interface such as parallel advanced technology attachment (PATA), serial advanced technology attachment (SATA) or otherwise, which may be connected to the bus 915. In such embodiments, removing the hard drive may involve removing a cover of the mobile device 900 and removing screws or other fasteners that connect the hard drive 936 to support structures within the mobile device 900.

The removable memory devices 935-937 and their associated computer storage media, discussed above and illustrated in FIG. 9, provide storage of computer-readable instructions, program modules, data structures, and other data for the mobile device 900. For example, the removable memory device or devices 935-937 may store images taken by the mobile device 900, voice recordings, contact information, programs, data for the programs and so forth.

A user may enter commands and information into the mobile device 900 through input devices such as a key pad 941 and the microphone 942. In some embodiments, the display 943 may be touch-sensitive screen and may allow a user to enter commands and information thereon. The key pad 941 and display 943 may be connected to the processing unit 905 through a user input interface 950 that is coupled to the bus 915, but may also be connected by other interface and bus structures, such as the communications module(s) 932 and wired port(s) 940. Motion detection 952 can be used to determine gestures made with the device 900.

A user may communicate with other users via speaking into the microphone 942 and via text messages that are entered on the key pad 941 or a touch sensitive display 943, for example. The audio unit 955 may provide electrical signals to drive the speaker 944 as well as receive and digitize audio signals received from the microphone 942.

The mobile device 900 may include a video unit 960 that provides signals to drive a camera 961. The video unit 960 may also receive images obtained by the camera 961 and provide these images to the processing unit 905 and/or memory included on the mobile device 900. The images obtained by the camera 961 may comprise video, one or more images that do not form a video, or some combination thereof.

The communication module(s) 932 may provide signals to and receive signals from one or more antenna(s) 965. One of the antenna(s) 965 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 972. In turn, the GPS mechanism 972 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 900 may connect to one or more remote devices. The remote devices may include a personal computer, a server, a router, a network PC, a cell phone, a media playback device, a peer device or other common network node, and typically includes many or all of the elements described above relative to the mobile device 900.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system comprising, a device having a lock screen state, the device configured to receive at a component interface lock wallpaper information corresponding to current device context, the lock wallpaper information specifying lock wallpaper content to display when the device is in the lock screen state, the device further configured to obtain content based on the lock wallpaper information and to output that content to a device display screen.

2. The system of claim 1 wherein the current context corresponds to a currently playing podcast, and wherein the lock wallpaper information comprises content within metadata associated with the currently playing podcast or a reference to content in metadata associated with the currently playing podcast.

3. The system of claim 1 wherein the current context corresponds to a currently playing podcast, wherein the lock wallpaper information comprises one or more keywords within metadata associated with the currently playing podcast, and wherein the device obtains the content based on the one or more keywords by requesting a keyword-based search.

4. The system of claim 1 wherein the current context corresponds to a currently playing podcast, wherein the lock wallpaper information comprises one or more words recognized from speech in the currently playing podcast, and wherein the device obtains the content based on the one or more words by requesting a word-based search.

5. The system of claim 1 wherein the current context corresponds to a currently playing audio track.

6. The system of claim 1 wherein the current context corresponds to an application program that is running as a foreground or background application, and wherein the lock wallpaper information comprises content specified by the application program.

7. The system of claim 1 wherein the content comprises an advertisement.

8. The system of claim 1 wherein the current context corresponds to an automatic change event, and wherein the lock wallpaper information comprises a reference to other lock wallpaper content that is different from currently displayed lock wallpaper content based upon the automatic change event.

9. The system of claim 8 wherein the currently displayed lock wallpaper content and the other lock wallpaper content are obtained from a social network source store.

10. The system of claim 8 wherein the currently displayed lock wallpaper content and the other lock wallpaper content are obtained from a set of favorites.

11. The system of claim 8 wherein the device is remotely configured to select the currently displayed lock wallpaper content from a specified source at a first event, and to select the other lock wallpaper content from the specified source at a second event.

12. The system of claim 1 wherein the automatic change event corresponds to a user gesture.

13. In a computing environment, a method performed at least in part on at least one processor, comprising, displaying first lock wallpaper content, and displaying second lock wallpaper content that is different from the first lock wallpaper content in response to an automatic change event.

14. The method of claim 13 further comprising, selecting the second lock wallpaper content from information associated with a currently playing podcast, including by accessing podcast metadata that specifies the lock wallpaper content, by accessing metadata from which one or more keywords are useable to search for content, or by obtaining text from speech recognition of the podcast corresponding to one or more keywords that are useable to search for content, or any combination of accessing podcast metadata that specifies the lock wallpaper content, by accessing metadata from which one or more keywords are useable to search for content, or by obtaining text from speech recognition of the podcast corresponding to one or more keywords that are useable to search for content.

15. The method of claim 13 further comprising, selecting the second lock wallpaper content from information provided by a currently running application program or service.

16. The method of claim 13 further comprising, selecting the second lock wallpaper content from a set of specified favorites, including by time-based selection, or by user gesture selection, or by both time-based selection and user gesture selection.

17. The method of claim 13 further comprising, selecting the second lock wallpaper content from a social network source store.

18. The method of claim 17 wherein selecting the second lock wallpaper content occurs via time-based selection, or by a social network-provided notification, or by both time-based selection and a social network-provided notification.

19. One or more computer-readable media having computer-executable instructions, which when executed perform steps, comprising:
automatically changing device lock wallpaper on a device display screen by displaying lock wallpaper selected from a set of user-specified content at a user-defined interval; and
automatically changing the device lock wallpaper before the user-defined interval based upon detecting a user gesture.

20. The one or more computer-readable media of claim 19 having further computer-executable instructions comprising, removing or fading out other information displayed on the device display screen in response to detecting the user gesture, and restoring or fading in the other information in response to not detecting further user gesturing within a time interval.
